(19) United States
(12) Patent Application Publication
(10) Pub. No.: US 2008/0224001 A1
(43) Pub. Date: Sep. 18, 2008

(54) Upright support protector for children and pets

(76) Inventor: Patricia A. Balbirnie, Downingtown, PA (US)

Correspondence Address: Invent This! Inc.;The Law Office of Anthony R. Carlis, P.O. Box 72333, Thorndale, PA, 19372, US

(21) Appl. No.: 11/724,874

(22) Filed: Mar. 16, 2007

(51) Int. Cl. F16M 11/20

(52) U.S. Cl. 248/188.8

(57) ABSTRACT

The present invention generally relates to protecting marring the finish of table legs or posts from pets and children. More importantly, the present invention help saves children, adults and pets from harm by cushioning and deflecting them from blunt and sharp edges on vertical upright supports. The present invention provides a soft covered buffer wrap to absorb, deflect and/or guide the child away from any sharp or hard surfaces such as a wooden table leg with corners in its design. In another embodiment, the present invention can be utilized as a mountable clamp-on device to protect furniture in general from children and pets by providing an alternative puppy chewing point and feline scratching apparatus.

This application claims priority of a provisional application filed on Mar. 16, 2006.

### BACKGROUND OF THE INVENTION

As any parent knows, as a child learns to walk, they will often lose their balance, stumble and fall. It is very disheartening to watch one's child fall into a table leg or banister as he or she take their first steps. If the child gets hurt, the injury is often limited to a small bruise or skin discoloration. An adverse effect of learned locomotion due to falling may lead to delayed developmental motor skills in these children. The child may become “gun shy” due to pain avoidance involved in this learning discovery process of walking.

Older adults:

As the graying of America's Baby Boomers occur, they, too, will often find themselves the victim of falls which might result in broken bones and other contusions. The once ridiculed “I've fallen and I can't get up” phenomenon has become all too apparent to this generation. For example, if a graying boomer should lose his or her balance and fall, they could possibly hit an upright support, such as a table leg which will profoundly increase the number of injuries that he or her could sustain. To make matters worse, the boomer who is living alone enjoying their freedom could incur a head injury by falling and striking any vertical post. It may take days for someone to come to their aide and provide the necessary assistance.

Pet issues:

The popularity of Labrador Retrievers is growing in the United States as well as many other countries throughout the world. As these larger dogs age, they may develop hip dysplasia. This condition may cause the dog to lose its balance due to the increase in pain and may unintentionally fall into a table leg and mar the table leg's paint or stained finish. This condition is not limited to Labrador Retrievers; many larger breeds can also develop hip dysplasia. Even worse, the dog may hurt itself as it strikes a corner of the support.

Additionally, most puppies and young dogs of any breed love to chew anything not nailed down. It is a natural part of the dogs teething process where the puppies' first teeth are replaced with their adult teeth. Puppies will often find a table leg to be a tasty treat while it provides them the relief they need. Even older dogs who are bored or scared will chew on furniture to send a message to their owners.

Cats, on the other hand, have a natural inclination to stretch and to flex the claws in their paws. They often do this by scratching furniture, banister posts, door frames or visitor's legs in order to properly maintain their healthy claws and paws. Some owners of indoor cats purchase or make unsightly cat scratching posts which are unattractive and become an eyesore in a well and tastefully decorated house.

Therefore, what is needed is an easily mountable upright support protector for children, elder persons and pets which protects vertical supports posts. The mountable upright support protector should also deflect and cushion falls into sharp edge mountable upright supports. It could be utilized as a scratching device for any feline in need of stretching and flexing their claws. It should have a flexible and adjustable clamping mechanism enabling it to be securely attached to various objects, such as a household doorjamb, exposed wall end, stair banister, or other surfaces.

### SUMMARY

The present invention generally relates to protecting marring the finish of table legs or posts from pets and children. More importantly, the present invention help saves children, adults and pets from harm by cushioning and deflecting them from blunt and sharp edges on vertical upright supports. The present invention provides a soft covered buffer wrap to absorb, deflect and/or guide the child away from any sharp or hard surfaces such as a wooden table leg with corners in its design. In another embodiment, the present invention can be utilized as a mountable clamp-on device to protect furniture in general from children and pets by providing an alternative puppy chewing point and feline scratching apparatus.

### BRIEF DESCRIPTION OF THE DRAWING

FIG. 1 illustrates a possible layout of the present invention.

FIG. 2 shows the present invention affixed to a table leg.

### DETAILED DESCRIPTION OF THE PREFERRED EMBODIMENTS

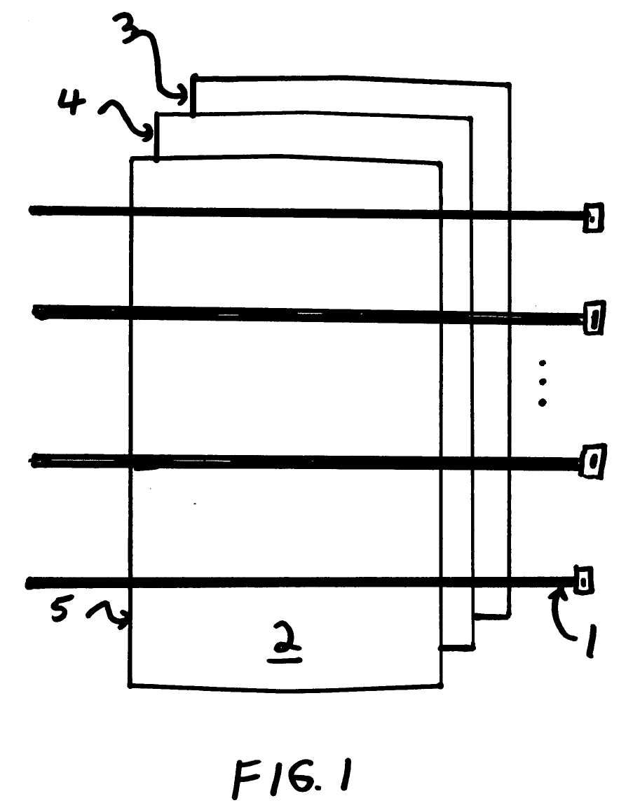

An upright support protector for children and pets assembly that securely mounts to a table leg or any vertical upright post now will be described in detail with reference to the attached drawing FIG. 1.

The protector 2 is formed by an outer structure 5 is formed from a material such as carpet backing or any burlap type material. A second layer may be attached to as a reinforcing material layer 4 to provide strength, rigidity and shaping. An additional third or inner layer 3 may also be added to cushion the outer structure 5 and/or to the reinforcing material layer 4 from the upright support. Wire ties 1 are then are affixed to the fifth layer.

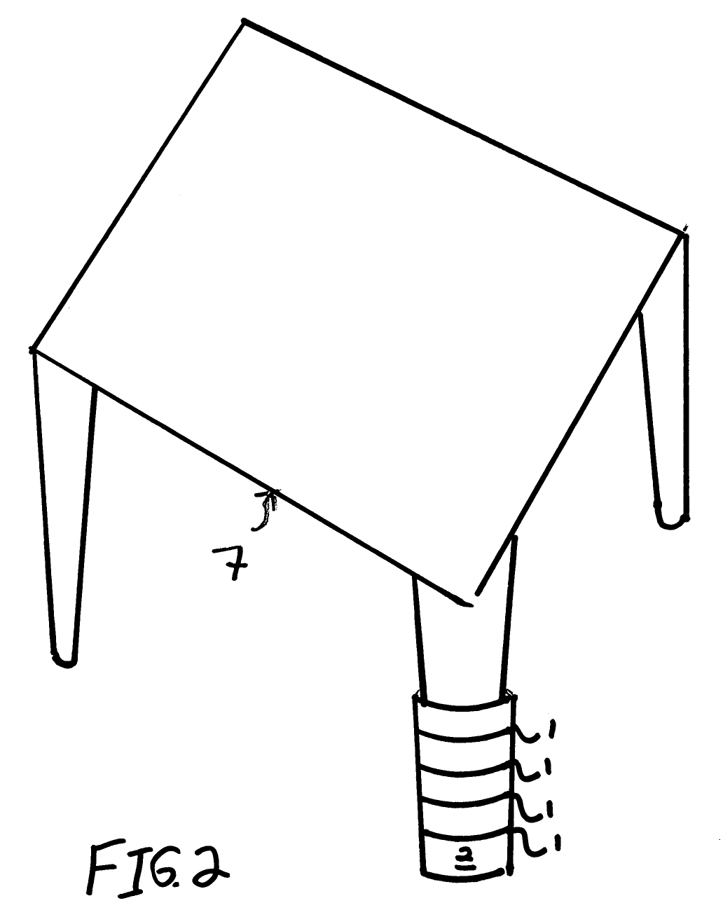

As shown in FIG. 2. The protector 2 is shown affixed to a table leg 7. To utilize the present invention, the protector 2 is first wrapped around the upright support. The wire ties 1 are then operated forming a secure wrap around the upright support.

To make the present invention more versatile, the protector 2 may employ an easily attachable and un-attachable devices, such as Velcro instead of the wire ties 1. This permits the protector to be moveable from location to location. In addition, other materials may be utilized such as glue, hook and loop fasteners or any types of snaps, or buttons permitting the protector 2 to be wrapped around to meet it self.

Although only a several embodiments of the upright support protector 2 for children and pets assembly are disclosed herein, it will be obvious to those having ordinary skill in the art that changes and modifications may be made thereto without departing from the scope of the present invention.

What is claimed is:

1. An easily mountable upright support protector for children and pets comprising:
an structure formed from a first material such as carpet or any burlap type material, and
a means for affixing said outer structure to said upright support.

2. The easily mountable upright support protector for children and pets in claim 1 further comprising a second layer.

3. The easily mountable upright support protector for children and pets in claim 1 further comprising a second layer and a inner layer which cushions said upright support from upright support protector.

4. The easily mountable upright support protector for children and pets in claim 1 further comprising a second layer to provide rigidity.

5. The easily mountable upright support protector for children and pets in claim 1 further comprising at least one of plurality of layers to provide rigidity and a inner layer to cushion said upright support from upright support protector.

6. The easily mountable upright support protector for children and pets in claim 1, wherein means for affixing said upright support protector utilizes at least one of plurality of wire ties.

7. The easily mountable upright support protector for children and pets in claim 1, wherein means for affixing said upright support protector utilizes at least one of plurality of wire ties affixed to said upright support protector.

8. The easily mountable upright support protector for children and pets in claim 1, wherein means for affixing said upright support protector utilizes glue, Velcro, snaps, buttons, or any refastenable material.

9. The easily mountable upright support protector for children and pets in claim 1, wherein means for affixing said upright support protector utilizes at least one of plurality of Velcro, snaps, buttons, or any refastenable material affixed to said upright support protector.

10. An easily mountable upright support protector for children and pets comprising:
a solid structure formed from molded plastic or any other moldable material a means for affixing said outer structure to said upright support.

11. A method for using an easily mountable upright support protector for children and pets comprising the steps of:
forming a structure formed from a first material such as carpet or any burlap type material, and
affixing said outer structure to said upright support.

12. The method for using an easily mountable upright support protector for children and pets of claim 11 further comprising:
adding at least one of plurality of layers to form the easily mountable upright support protector.

13. The method for using an easily mountable upright support protector for children and pets of claim 11 further comprising:
adding at least one of plurality of layers and an inner layer to cushion said upright support from upright support protector.

14. The method for using an easily mountable upright support protector for children and pets of claim 11 further comprising:
making said easily mountable upright support protector in different colors and finishes to match different decors.

15. The method for using an easily mountable upright support protector for children and pets of claim 11 further comprising:
adding at least one of a plurality of layers to provide rigidity and an inner layer to cushion said upright support from upright support protector.

16. The method for using an easily mountable upright support protector for children and pets of claim 11 further comprising:
affixing said upright support protector utilizes at least one of plurality of wire ties.

17. The method for using an easily mountable upright support protector for children and pets of claim 11 further comprising:
adding at least one of plurality of wire ties affixed to said upright support protector.

18. The method for using an easily mountable upright support protector for children and pets of claim 11 further comprising:
affixing said upright support protector from glue, Velcro, snaps, buttons, or any refastenable material.

19. The method for using an easily mountable upright support protector for children and pets of claim 11 further comprising:
affixing said upright support protector utilizes at least one of plurality of Velcro, snaps, buttons, or any refastenable material affixed to said upright support protector.

20. An easily mountable upright support protector for children and pets comprising:
molding a solid structure from one or more of a plethora of materials, and
providing means for affixing mountable upright support protector for children and pets to an upright support.
